(19) United States
(12) Patent Application Publication
(10) Pub. No.: US 2009/0039128 A1
(43) Pub. Date: Feb. 12, 2009

(54) Suspended liquid bladder for vehicles

(76) Inventor: Kenneth T. Damico, Tijeras, NM (US)

Correspondence Address: RODEY, DICKASON, SLOAN, AKIN & ROBB, PA, P.O. BOX 1888, ALBUQUERQUE, NM, 87103, US

(21) Appl. No.: 11/890,631

(22) Filed: Aug. 6, 2007

(51) Int. Cl. B60R 9/00

(52) U.S. Cl. 224/572

(57) ABSTRACT

A fluid reservoir system for use in vehicles comprising a fluid-holding bladder within a support bag, wherein the bladder has a valve connected to a tube running from the bladder to allow a user to withdraw fluid from the bladder as desired. The support bag is secured within a vehicle, such as by suspending it from a vehicle's roll bar or by securing it to the back of a seat of a vehicle.

### FIELD OF THE INVENTION

The present invention relates to a fluid reservoir, and more particularly to a hydration system adapted for use in a vehicle.

### BACKGROUND OF THE INVENTION

The importance of maintaining a proper level of hydration during physical or athletic activities is well-known. Engaging in such activities poses some risk of dehydration if a person does not maintain an adequate fluid intake level. Additionally, dehydration to varying degrees may occur during activities in certain environmental conditions, such as high altitude and elevated temperatures. Persons engaging in such activities typically carry water (or other fluids) in bottles or other hand-held containers. In the recent past, hydration systems, such as that disclosed in U.S. Pat. No. 6,675,998, with a fluid reservoir carried in a bag, sack, backpack, waist pack, or similar carrying device have been developed and grown in popularity. However, these systems are designed to be carried by a person on their body, which limits their uses in some instances, such as where a person is seated in a vehicle, or where larger quantities of water are needed, such as at a camp on backcountry trails.

### SUMMARY OF THE INVENTION

The present invention comprises a fluid reservoir system for use in vehicles, and is especially designed for off-road and backroad situations. The fluid reservoir system comprises a fluid-holding bladder within a support bag, wherein the bladder has a valve connected to a tube running from the bladder to allow a user to withdraw fluid from the bladder as desired. The support bag is secured within a vehicle, such as by suspending it from a vehicle's roll bar (roll cage) or other fixed point in a vehicle (such as by securing it to the back of a seat of a vehicle). Additionally, the bladder and the support bag each have grommets that align with each other to allow a hook or carabiner or similar device to be passed through the grommets and connected to a support structure to aid in retaining the bladder in an upright position.

### DESCRIPTION OF ATTACHED FIGURES AND PICTURES

FIG. 1 is a front view of the preferred embodiment of the present invention suspended from a roll bar of a vehicle.

FIG. 2 is a front view of the preferred embodiment of the present invention suspended from a roll bar of a vehicle wherein some hidden portions of the invention are depicted.

FIG. 3 is a perspective view of one embodiment of the bladder of the present invention.

FIG. 4 is a back view of the preferred embodiment of the present invention suspended from a roll bar of a vehicle.

FIG. 5 is a front view of an alternative embodiment of the present invention attached to a seatback.

### DESCRIPTION OF PREFERRED EMBODIMENT OF THE INVENTION

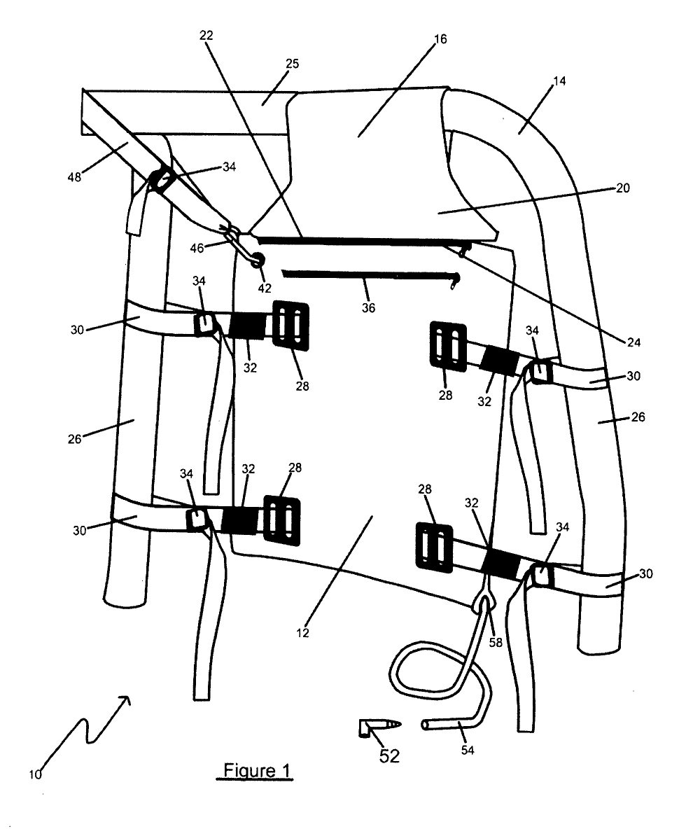

With reference to the figures, the present invention will be described. The present invention is a hydration system designed for use in a vehicle, but it may be adapted for other applications as well. As shown in FIGS. 1-2 and 4-5, the present invention 10 includes a support bag 12, preferably made from a 1000# cordura nylon. Support bag 12 may be any of a variety of shapes as desired to fit a particular vehicle application. Support bag 12 is preferably suspended from roll bar 14, seat 56, or some other sturdy feature of a vehicle.

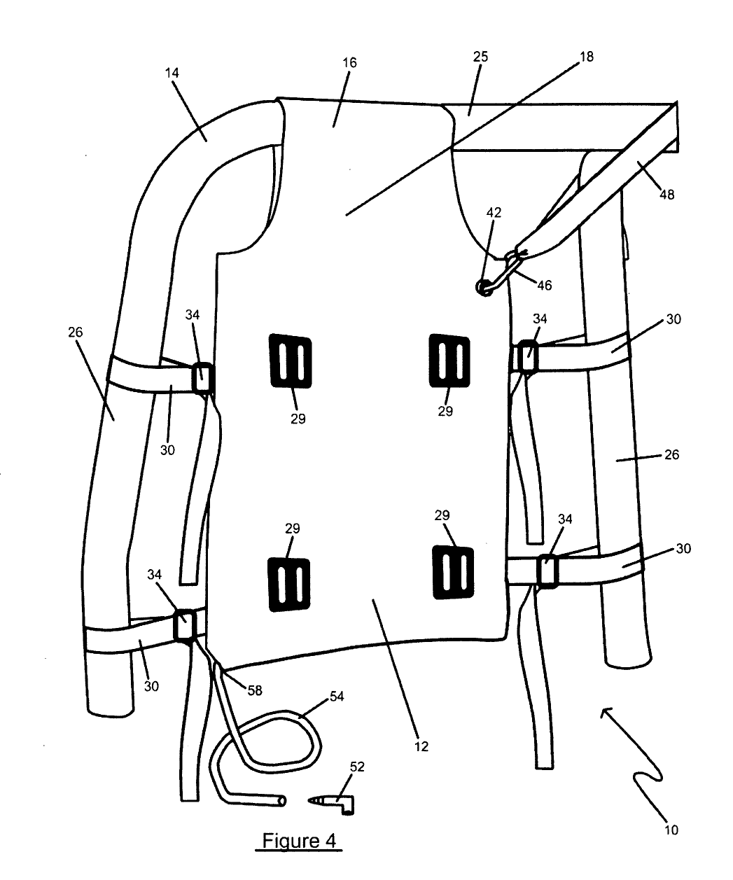

The preferred embodiment of invention 10 includes a 10″ wide strap 16 connected to the top of support bag 12 and made from the same material as support bag 12. Strap 16 is preferably a continuation of support bag 12 at first end 18 of strap 16 such that first end 18 is preferably integrated into the material of support bag 12, as depicted in FIG. 4. Strap 16 is of a length to allow it to be wrapped over roll bar 14. Strap 16 is preferably of a width such that it distributes the weight of support bag 12 across an area of roll bar 14 to stabilize support bag 12 and aid in reducing the movement of support bag 12 relative to roll bar 14 when suspended from roll bar 14. Second end 20 of strap 16 has one side of a zipper 22 that is adapted to work in conjunction with a second side of a zipper 24 that is located on support bag 12, thereby securing second end 20 to support bag 12. In this manner, support bag 12 may be suspended from horizontal section 25 of roll bar 14. Additionally, support bag 12 is adapted to be secured to vertical sections 26 of roll bar 14, as discussed below.

Support bag 12, as depicted in FIG. 1, includes four rectangular anchors 28 (sometimes referred to as 4-way ties), straps 30, and quick-disconnect buckles 32. Straps 30 have interacting portions of buckles 32 at either end of each strap, and straps 30 are fed through anchors 28 so as to enable straps 30 (when the interacting ends are connected) to secure support bag 12 to vertical sections 26 of roll bar 14. Additionally, straps 30 include adjustment buckles 34 to allow the lengths of straps 30 to be adjusted as desired or required for a particular application. Additional anchors 29, as depicted in FIG. 4, are located on the side of support bag opposing the side that has anchors 28 to allow for flexibility in adapting the invention 10 to various situations and uses.

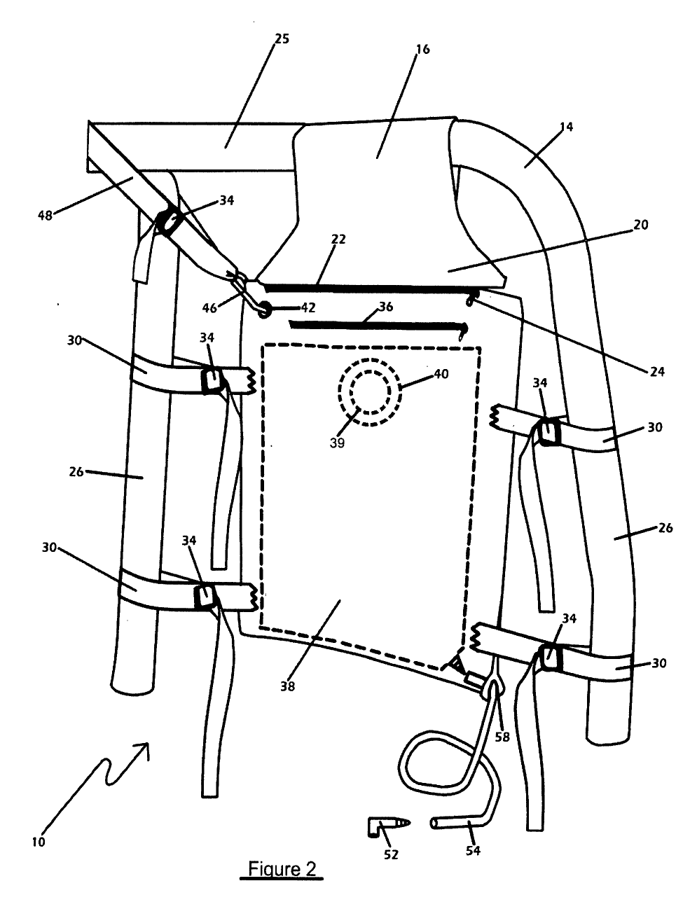

Support bag 12 also includes access aperture 36 to allow the insertion and removal of liquid bladder 38 (discussed in detail below). Access aperture 36 is preferably a zipper closure, as depicted, and is preferably located on support bag 12 such that it is positioned with or near filling cap 40 of bladder 38 (see FIG. 2) to make refilling bladder 38 more convenient because bladder 38 does not have to be removed from support bag 12 to gain access to filling cap 40.

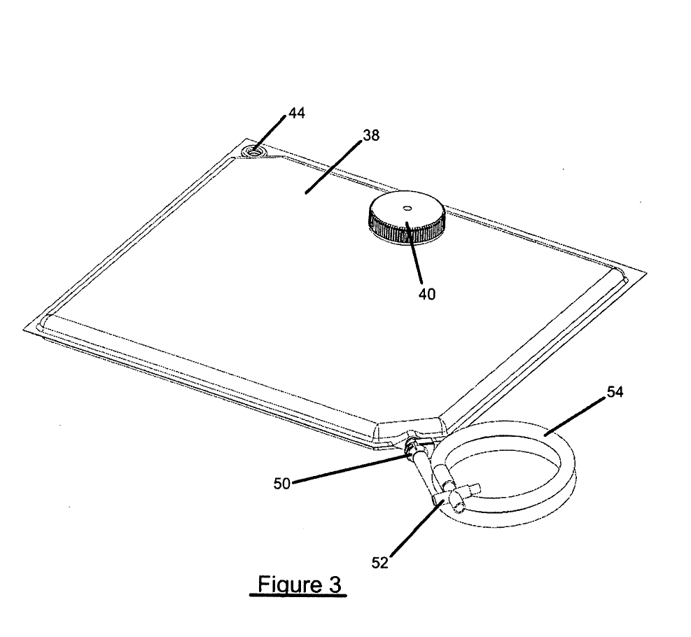

Support bag 12 further includes grommet 42 located at or near the top of support bag 12. Grommet 42 aligns with bladder grommet 44 (see FIG. 3), and is sized to allow carabiner 46 to pass through grommet 42 (as well as grommet 44). Carabiner 46 is connected to strap 48, which in turn is connected to or supported by horizontal section 25 of roll bar 14 or some other sufficient attachment point within a vehicle. In this way, bladder 38 is assisted in remaining properly aligned and upright in support bag 12 to aid in counteracting vehicle movements and gravity that would otherwise tend to cause bladder 38 to be misaligned in support bag 12. Maintaining an upright alignment aids in refilling bladder 38 and in ensuring an unobstructed flow of fluid out of bladder 38. Alternative embodiments may include the use of multiple grommets and carabiner/strap combinations, or the use of other methods of maintaining the alignment of bladder 38 by applying an upward force to the top of bladder 38, whether through a flexible strap/cord or a rigid device.

With primary reference to FIG. 3, fluid-holding bladder 38 is depicted. In the depicted embodiment, bladder 38 is an antimicrobial bladder made from a CXCR material. Of course, bladder 38 may be made from a variety of flexible, fluid-retaining materials, as is well-understood in the art. The depicted rectangular bladder is approximately 15.75 inches in length and 16 inches in width and of a ten liter capacity, but bladder 38 may be any of a variety of dimensions, shapes, and capacities as desired or necessary to fit a particular application. As noted previously, bladder 38 includes grommet 44 through which carabiner 46 (or any other component, such as a hook, that is used to aid in supporting bladder 38 in an upright position) passes. Filling cap 40 removably covers and seals filling aperture 39, which allows bladder 38 to be emptied, refilled, and/or cleaned. Bladder 38 also includes quick-disconnect device 50 coupled to bladder 38 through which fluid may flow out of or into bladder. Device 50 aids in preventing leaking from bladder 38 and allows tubing 54 to be quickly and easily disconnected and replaced with an alternative tubing and mouthpiece (for example, a bite valve versus a cross drain valve). As illustrated, device 50 is connected to valve 52 via ⅜″ polypropylene anti-microbial tubing 54, which may vary in length, diameter, and material as desired or necessary to fit a particular application. As is well understood in the art, a user may draw fluid out of bladder 38 through tubing 54 and an opening in valve 52. Tubing 54 feeds through aperture 58 of support bag 12 to allow the user access to valve 52 at the end of tubing 54. Aperture 58 also may allow a user to access device 50 without requiring the removal of bladder 38 from support bag 12.

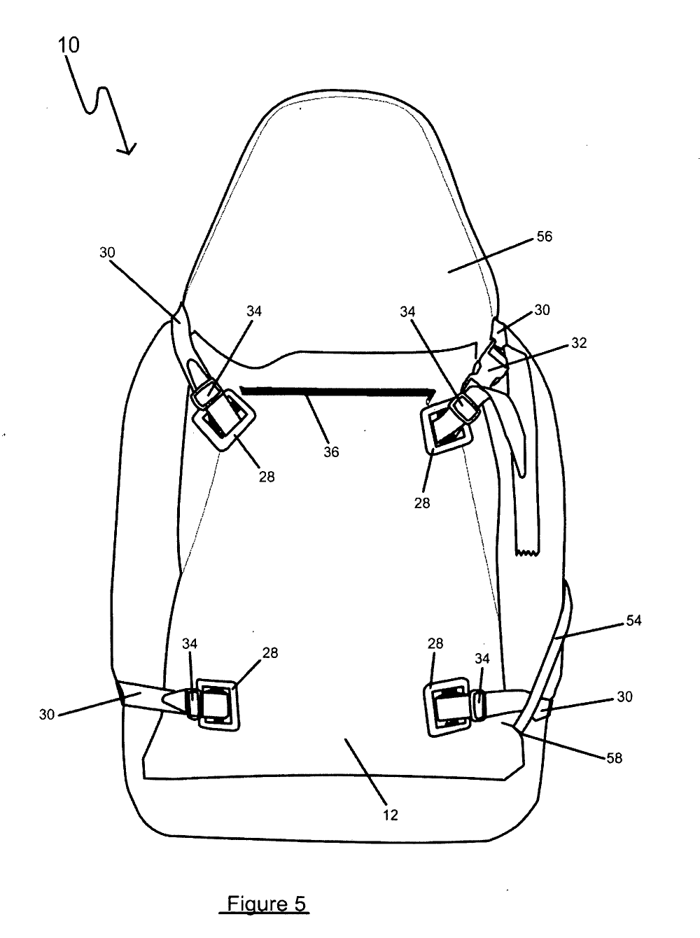

With reference to FIG. 5, an alternative embodiment of the present invention is depicted. In this alternative embodiment, support bag 12 is removably attached to the back of vehicle seat 56 via straps 30 that wrap around seat 56. As discussed above, anchors 28 serve as attachment points on support bag 12 for straps 30, and quick-disconnect buckles 34 at the ends of straps 30 allow flexibility in securing support bag 12 to seat 56 or suspending it from a roll bar (as depicted in FIGS. 1-2 and 4). In this embodiment, strap 16 (not visible in FIG. 5) may be folded down between support bag 12 and seat 56 since it is not necessary for securing support bag 12 in this alternative embodiment.

In an alternative embodiment, the location of zipper 24 relative to a horizontal plane may be angled such that the bottom corner of support bag 12 at which aperture 58 is located is lower than the other bottom corner, which causes gravity to act on the fluid within bladder 38 and cause the fluid to gather more substantially at the lower bottom corner. This allows gravity to more effectively draw the fluid out of bladder 38 when a user is relying on gravity for such a purpose, rather than by applying a suction force to tubing 54.

Whereas the figures and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted. For example, the present invention may be modified for use in a variety of vehicles by altering the shape, capacity, and suspension/securement mechanisms and locations.

What is claimed is:

1. A fluid reservoir system comprising:
(a) an outer support bag and a bladder, said outer support bag having a first top edge portion and an outward facing surface and a compartment sized to receive said bladder, said bladder removably located within said compartment of said outer support bag, said bladder including a second top edge portion and adapted to be filled with and retain a fluid, said bladder having a first opening with a removable cover for selectively closing and sealing said first opening through which said fluid may be added to or removed from said bladder;
(b) said outer support bag including a first grommet located at or adjacent to said first top edge portion of said support bag, said bladder including a second grommet located at or adjacent to said second top edge portion of said bladder, said first grommet and said second grommet oriented such that they align when said bladder is received within said compartment of said outer support bag;
(c) said outer support bag further including a suspension strap adapted to suspend said outer support bag from a substantially horizontal member of a vehicle, said suspension strap having a first end connected to said support bag at or adjacent to said first top edge portion of said support bag on a first side of said support bag; and
(d) a plurality of straps connected to said support bag and adapted to couple to fixed points within a vehicle.

2. The fluid reservoir system of claim 1 further comprising a tube having a first end region coupled to said bladder via a disconnect mechanism located between said bladder and said first end region of said tube, said tube having a second end region distal to said first end region and a mouthpiece coupled to said second end region.

3. The fluid reservoir system of claim 1, further comprising a means for applying a gravity-opposing force to said first grommet and said second grommet such that said bladder remains substantially upright within said compartment of said outer support bag.

4. The fluid reservoir system of claim 3, wherein said means for applying said gravity-opposing force includes a carabiner and a holding strap, said holding strap adapted to be coupled to a fixed point within said vehicle located at a position vertically greater than the position of said first and second grommets.

5. The fluid reservoir system of claim 1, wherein said first end of said suspension strap is integrated with said first side of said support bag.

6. The fluid reservoir system of claim 1, wherein said first end of said suspension strap is a seamless continuation of said first side of said outer support bag.

7. The fluid reservoir system of claim 1, wherein said second end of said suspension strap includes a first side of a disconnect means and said second side of said support bag includes a second side of said disconnect means such that said second end of said suspension strap may be connected to said second side of said support bag by joining said first and second sides of said disconnect means.

8. The fluid reservoir system of claim 7, wherein said disconnect means includes a zipper.

9. The fluid reservoir system of claim 1, wherein said suspension strap is adapted to be looped over said substantially horizontal member and said second end of said suspension strap is adapted to be connected to said outer support bag.

10. The fluid reservoir system of claim 1, wherein said suspension strap is at least three inches wide.

11. The fluid reservoir system of claim 1, wherein said suspension strap is ten inches wide

12. The fluid reservoir system of claim 1, wherein said plurality of straps are adapted to be coupled to substantially vertical portions of a roll bar of said vehicle.

13. The fluid reservoir system of claim 1, wherein said outer support bag is adapted to be secured to a seat of said vehicle.

14. The fluid reservoir system of claim 13, wherein said plurality of straps are adapted to wrap around the seat of said vehicle.

15. The fluid reservoir system of claim 1, wherein said outer support bag is adapted to be suspended from a group consisting of either a roll bar, roll cage or seat of a vehicle.

16. The fluid reservoir system of claim 1, wherein said outer support bag further comprises a plurality of strap anchors located an outward facing surface of said outer support bag.

17. The fluid reservoir system of claim 1, wherein each of said plurality of straps includes a quick-disconnect buckle.

18. The fluid reservoir system of claim 1, wherein said outer support bag further comprises a second opening, said second opening providing access to said compartment and including a zipper closure.

19. The fluid reservoir system of claim 18, wherein said second opening is positioned on said outer support bag such that said second opening aligns with said first opening when said bladder is received within said compartment as intended.

20. The fluid reservoir system of claim 1, wherein said plurality of straps comprises second, third, fourth and fifth straps connected to the first side of said outer support bag.

21. The fluid reservoir system of claim 1 wherein said suspension strap further includes a second end adapted to be connected to said support bag at or adjacent to said top edge portion of said support bag on a second side of said support bag.
